(19) United States
(12) Patent Application Publication
(10) Pub. No.: US 2006/0203288 A1
(43) Pub. Date: Sep. 14, 2006

(54) Registration of two-sided printing systems and methods

(75) Inventors: Roman D. Liccini, Los Angeles, CA (US); Nishan D. Hossepian, Redondo Beach, CA (US)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(73) Assignee: Xerox Corporation

(21) Appl. No.: 11/078,085

(22) Filed: Mar. 11, 2005

(51) Int. Cl. G06K 15/00

(52) U.S. Cl. 358/1.18; 358/527

(57) ABSTRACT

Embodiments herein generally relate to registration of two-sided printing systems and methods that allows both sides of a printed sheet to be simultaneously displayed on a graphic user interface to allow each side to be aligned (registered) with each other and with the printing medium.

### BACKGROUND

Embodiments herein generally relate to registration of two-sided printing systems and methods that allow both sides of a printed sheet to be simultaneously displayed on a graphic user interface to allow each side to be aligned (registered) with each other and with the printing medium. Conventional two-sided printing systems are described in U.S. Pat. Nos. 5,666,208, and 5,625,766 (hereinafter “conventional patents”) the complete disclosures of which are incorporated herein by reference.

Electronic printing system afford high levels of editing capability in which stored images can be displayed and manipulated with respect to one another. For example, a first image can be merged relative to a second image at a selected location in the second image and formatted data on a document designated for printing can be merged with electronically generated forms and optional masks. Electronic printing systems have the ability to shift or rotate an image and then store the same for subsequent output. For example, images on the back side of a duplex print can be automatically shifted so that all of such back side images fit on the back side of the page. Also electronic printing system can overlay a first image relative to a second image. An example of the sort of technology that makes overlay functionality possible in electronic printing systems, is disclosed by U.S. Pat. No. 4,897,803 (incorporated herein by reference). Publicly available electronic reprographic systems make this overlay feature, in which the first image is superposed on the second image and the second image can be “seen through” the first image, possible.

Through much of the 20th century, draftspeople, engineers and others have aligned images through use of physically superposing one image relative to another in an arrangement commonly referred to as a “light table”. A light table can be used conjunctively with an electronic printing system so that stored images can be printed and one or more hardcopy pages can be superposed relative to one or more other hardcopy pages. In particular, an operator would register output sheets and visually check image alignment or registration by backlighting or fanning the sheets. This approach is disadvantageous in that the cumulative capacity of the paper stock used for proof sheets limits the number of pages that can be registered relative to one another. Also, this approach wastes paper, physical manipulation of the proof sheets is time consuming and iterative (trial and error), and for a duplexed page, manipulation of the back side image relative to the front side image is not possible.

It would be desirable to provide a light table technique that both eliminates the need to manipulate physical pages on a table and permits easy viewing of images relative to one another even when a plurality of images are registered in a stack of pages. That is, it would be desirable to provide a wholly electronic light table that makes alignment of stored images both quick and easy.

### SUMMARY

Embodiments herein provide a printing/copying system. An input is adapted to receive printing data from such items as a scanner, word processor, graphics software program, and similar items. This printing data can comprise rasterized data, unrasterized data, portable document format (PDF) data, text, images and other similar data. A processor (such as a computer, central processing unit, printer processor, copier processor, facsimile processor, and similar items) is adapted to arrange the printing data to be printed on both sides of a printing medium (such as sheets of paper, transparencies, card stock, and similar items) as an image. The printing can be duplex printing (where the pages are designed to be turned horizontally) or tumble printing (where the pages are designed to be flipped vertically).

A graphic user interface (such as a touch screen, liquid crystal display, plasma display, cathode ray tube, projector, and similar items, combined with tactile inputs such as buttons, keypad/keyboard, mouse, touchpad, trackball, and similar items) is adapted to display the image. The processor is further adapted to overlay the first page of said printing data on the next consecutive page of said printing data in said image, such that the first page and the next consecutive page are simultaneously displayed in a one sided document image using different colors in said image.

The graphic user interface can display at least one alignment guide. The logical relationship and/or the alignment of the front and back page can be compared with each other and/or with the printing medium. The graphic user interface includes inputs (such as a touch screen, buttons, keypad/keyboard, mouse, touchpad, trackball, and similar items) adapted to shift the relative position of the entire front page with respect to the entire back page in the image using page offsets that uniformly adjust positions of all items in the front page and/or the back page. Alternatively, individual items (such as images, paragraphs, margins, tables, and similar items) can be individually moved on the front page and/or the back page using the graphic user interface inputs. The graphic user interface inputs are also adapted to select colors for display of the front page and the back page on the graphic user interface.

The printing data can comprise data to be printed on multiple sheets of the printing medium. Therefore, the graphic user interface inputs are also adapted to apply shifting of the relative position of the front page with respect to the back page for one sheet of printing medium to all the sheets of the printing medium. The graphic user interface can display a plurality of thumbnail images of printing medium sheets, wherein each thumbnail image illustrates a thumbnail front-page overlaid on a thumbnail back page using different colors.

The front page and/or the back page can comprise color printing data. The graphic user interface can be adapted to display the front page and the back page using various color transformations or effects in the image. Alternatively, if the printing data comprises black and white image data, the graphic user interface can be adapted to display the front page using the scale-to-gray transformation well-known within the imaging industry. After being mirrored vertically or horizontally, the back page can also be scaled to gray, but the color palette (e.g., a 256 color palette) can be replaced with a new palette using, for example, 256 tints between white and a user-specified preview color rather than 256 shades of gray used to display grayscale. Color data can be handled in a similar manner after it has been converted to grayscale using well-known methods. After these two representations of the front and back pages have been created, these two images can then be blended together by applying a logical OR to the pixels making up the pages. This resultant preview enables the human eye to easily discern not only whether a registration problem exists, but which page needs to be moved. Note this procedure can be accomplished with or without a visible guide that marks a user-specified distance from the edge of the paper. With this methodology in place, operators can quickly make corrections by moving the problematic content in the correct direction to rectify any registration issues.

A printing method embodiment inputs printing data arranged to be printed on both sides of a printing medium and then displays the image of the printing data on a graphic user interface. This overlays the first page of the printing data on a next consecutive page of the printing data in the image, such that the first page and the next consecutive page are simultaneously displayed in a one sided document image using different colors in the image. This embodiment also permits moving of the position of one or more items relative to other items on the first page and/or the next consecutive page using the graphic user interface.

The method embodiment allows shifting of the relative position of the first page with respect to the next consecutive page in the image using page offsets that uniformly adjust positions of all items in the first page or the next consecutive page. The user is allowed to select colors for display of the first page and the next consecutive page on the graphic user interface. The displaying process can display a plurality of thumbnail images of printing medium sheets on the graphic user interface. Each thumbnail image illustrates a thumbnail first page overlaid on a thumbnail next consecutive page using different colors.

Because the printing data comprises data to be printed on multiple sheets of the printing medium, the method embodiment further comprises applying the shifting of the relative position of the first page with respect to the next consecutive page for one sheet of printing medium to a group of the sheets of the printing medium.

When the first page and/or the next consecutive page comprise color printing data, the displaying process displays the first page and the next consecutive page using various color transformations or effects in the image. When the printing data comprises black and white image data, the displaying process displays the first page in black and white grayscale in the image, and displays the next consecutive page using a grayscale or color in the image.

These and other features are described in, or are apparent from, the following detailed description.

### BRIEF DESCRIPTION OF THE DRAWINGS

Various exemplary embodiments of the systems and methods described in detail below, with reference to the attached drawing figures, in which:

FIG. 1 is a schematic representation of a two-sided printing system according to embodiments herein;

FIG. 2 is a schematic representation of a two-sided printing image according to embodiments herein;

FIG. 3 is a schematic representation of thumbnails of two-sided printing images according to embodiments herein; and

FIG. 4 is a flow chart illustrating embodiments herein.

### DETAILED DESCRIPTION

While the following embodiments are described hereafter with reference to a two-sided printing/copying system, it should be understood that embodiments herein are not strictly limited to printing systems. Rather, any device that allows images to be combined is contemplated by this disclosure.

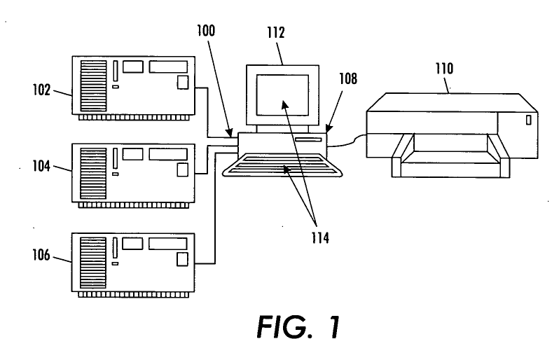

The systems and methods in the embodiments herein provide a printing/copying system such as a xerox graphic system that includes an input 100 that is adapted to receive printing data from such items as a scanner 102, word processor 104, graphics software program 106, and similar items. The details of these devices are discussed at length in the conventional patents, and reference is made thereto. For example, while individual components are illustrated in FIG. 1, the components can be combined into a single unit as is illustrated in FIG. 1 of U.S. Pat. No. 5,666,208.

This printing data can comprise rasterized data, unrasterized data, PostScript data, portable document format data, text, images, or any other data that has been converted to an acceptable format, such as PDF. Therefore, the system described herein processes not only black-and-white text, but also processes images, charts, vectors, and other similar items. Further, the embodiments herein provide two-sided registration of colorized images, charts, etc. mixed with text. Although systems exist to handle a single rasterized image appropriate for printing, data such as this is relatively simple to shift in its entirety. PDF data, on the other hand, is a multi-page collection of text, images, and vectors on each page, and requires adjustments to be performed using matrix manipulation. In this manner, PostScript data can be adjusted after it has been converted to PDF using well-known PostScript conversion tools such as Distiller (available from Adobe Systems Incorporated, San Jose, Calif., USA). Other formats can usually be converted to PostScript by printing to file, and then subsequently converted to PDF.

A processor 108 (such as a computer, central processing unit, printer processor, copier processor, facsimile processor and similar items) is adapted to arrange the printing data to be printed on both sides of a printing medium (such as sheets of paper, transparencies, card stock, and similar items) as an image. The printer is shown as item 110 in FIG. 1 and can comprise any type of printer including, but not limited to, a Xerographic-type printer, lithographic-type printer, inkjet-type printer, and similar items. The printing can be duplex printing (where the pages are designed to be turned horizontally) or tumble printing (where the pages are designed to be flipped vertically). The details of these devices and processes are discussed at length in the conventional patents, and reference is made thereto.

A graphic user interface 112 (such as a touch screen, liquid crystal display, plasma display, cathode ray tube, projector, and similar items, combined with tactile inputs such as buttons, keypad/keyboard, mouse, touchpad, trackball, and similar items) is adapted to display the image. The processor is further adapted to overlay a front page of the printing data on a back page of the printing data in the image. Again, the details of these devices and processes are discussed at length in the conventional patents, and reference is made thereto.

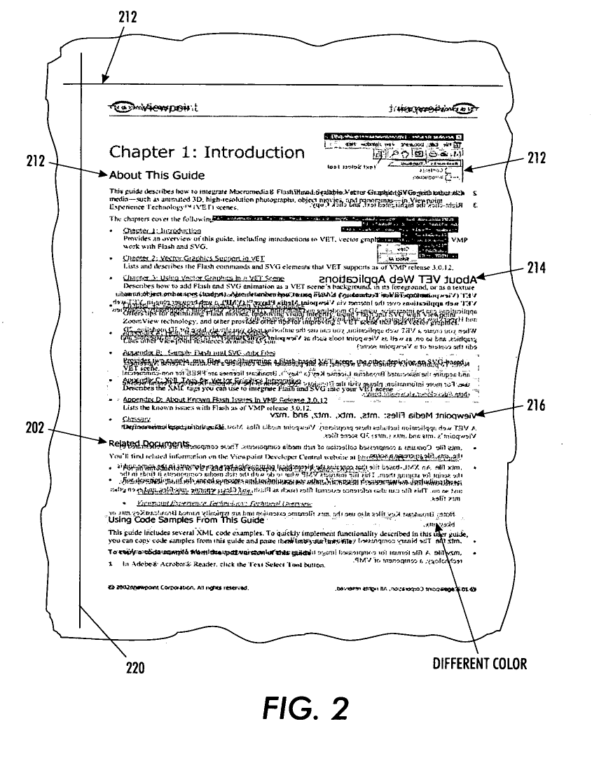

As shown in FIG. 2, the front page and the back page are overlaid using different colors/shading in the image. For example, items 200 and 202 point to headings that on the front page and items 212, 214, and 216 point to items that appear as a mirror image and are represented using a lighter shade (different scale, color, and/or grayscale). One-sided documents can also be used with this system, but in this case the system previews consecutive pages without mirroring. Therefore, items 212, 214, and 216 represent items that would be on the opposite side of the page from items 200, and 202 if a two-sided page were being viewed on a light table. Therefore, the embodiments herein provide a virtual light table by illustrating items such as items 212, 214, and 216 as a mirror image and using a different scale/color in combination with the normally displayed items 200 and 202. The back page is shown as a mirror image (either horizontally and/or vertically) as it would appear in a conventional mechanical light table. For example, the graphic user interface 112 can be adapted to display the front page in grayscale, and display the back page using the tinted grayscale described in the summary. Note that the user-specified color can be any combination of red, green, and/or blue, though the color must contrast significantly with gray in order to be useful. When testing the embodiments herein, pale colors were found to provide an experience similar to looking through a sheet of paper held up to the light, but they provided superior contrast. The color choices between the front page and the back page image representation are selected such that the differences allow a user or an automated software program to easily identify discrepancies between the front page and the back page.

In another example, the graphic user interface 112 can be adapted to display the front page and the back page in color (if either page has colorized features), but using various color transformations or effects in the image. Thus, for example, the front page can be rendered translucent by making the pixels partially transparent using alpha-channel transparency, and the back page can be rendered translucent using the same technique in front of a white background, resulting in a full-color light table preview with a somewhat muted appearance. The advantage of this scheme is that the colors are largely preserved. The disadvantage of this scheme is that it is difficult to pick out which content is on the front of the page, and which content is on the back of the page. Another possibility involves one page shown in color, while the other page is shown using a grayscale preview to allow the front page to be more easily distinguished from the back.

Thus, the graphic user interface further comprises an input adapted to select colors for display of the first page and the back page on the graphic user interface in the following manner. If the printing data comprises black and white image data, the graphic user interface can display the first page using the scale-to-gray transformation well-known within the imaging industry. After being mirrored vertically or horizontally, the back page can also be scaled to gray, but the color palette (e.g., a 256 color palette) can be replaced with a new palette using 256 tints between white and a user-specified preview color rather than 256 shades of gray used to display grayscale. Color data can be handled in a similar manner after it has been converted to grayscale using well-known methods. After these two representations of the first and back pages have been created, these two images can then be blended together by applying a logical OR to the pixels making up the pages. This resultant preview enables the human eye to easily discern not only whether a registration problem exists, but which page needs to be moved. Note this procedure can be accomplished with or without a visible guide that marks a user-specified distance from the edge of the paper. With this methodology in place, operators can quickly make corrections by moving the problematic content in the correct direction to rectify any registration issues.

The graphic user interface 112 includes inputs 114 (such as a touch screen, buttons, keypad/keyboard, mouse, touchpad, trackball, and similar items). The graphic user interface inputs 114 are also adapted to allow a user to select the different colors for display of the front page and the back page. Therefore, this feature is customizable for each user's preferences.

The graphic user interface 112 can also display at least one alignment guide 220, as shown in FIG. 2. A guide 220 is a non-printing, removable horizontal/vertical marker that designates a user-specified distance from an edge of the printing medium. Note that guides must automatically be mirrored appropriately when previewing the back pages. The logical relationship and/or the alignment of the front and back page can be compared with each other and/or with the printing medium. The alignment guide 220 can be useful in checking the alignment of the front and back page.

The graphic user interface inputs 114 can also be used to shift the relative position of the entire front page with respect to the entire back page in the image using page offsets. Like the page preview mechanism, the page adjustment mechanism is capable of moving everything from simple monochrome raster images to complex multi-object pages with color text vectors, and images. Matrix manipulation can be used to shift all the objects on a PDF page. As explained previously, PostScript data can be adjusted after it has been converted to PDF using well-known PostScript conversion tools such as Distiller. Other formats can usually be converted to PostScript by printing to file, and then subsequently converted to, for example, PDF.

Alternatively, individual items (such as images, paragraphs, margins, tables, and similar items) can be individually moved on the front page and/or the back page using the graphic user interface inputs 114. Thus, embodiments herein can move the position of one or more items relative to other items on either the first (front) page or the next consecutive (back) page. This can be accomplished in any number of different ways. For example, the user can click on a page (or item) and use a pointing device to move the entire page (or item within the front or back page). The aspects of moving items within a graphic user interface are discussed in, for example, U.S. Pat. No. 6,178,270 which is incorporated herein by reference and which in also included in the “conventional patents” discussed herein. To summarize, software on the Microsoft Windows (Microsoft Corp., Redmond Wash., USA) platform typically provides equivalent functionality on the keyboard and mouse. In most cases, this is simply a matter of convenience, but in the case of imaging applications, it provides a more capable interface for the user. The mouse enables the user to quickly make large adjustments to page position. The keyboard, on the other hand, enables the user to make precise adjustments to image position. Tapping a cursor keys enables the user to move the page one pixel at a time at the current screen resolution. Of course, the user can achieve additional precision with both the mouse and the keyboard by using the zoom feature. This feature enables the user to see less of the page at a time, but enables the user to make more precise adjustments to the position of the page content.

The printing data can comprise data to be printed on multiple sheets of the printing medium. Therefore, the graphic user interface inputs 114 are also adapted to apply shifting of the relative position of the front page with respect to the back page for one sheet of printing medium to all sheets one or more groups of sheets of the printing medium through selections of the graphic user interface inputs 114. Therefore, the shifting can be applied to a contiguous range of pages, possibly the entire document, or a non-contiguous group of pages where the user selects some combination of chapters, sections, ranges of pages, and/or individual pages. This can be accomplished using any well-known menu, such as a pull-down menu, a pop-up menu, a keyboard menu, or other similar items.

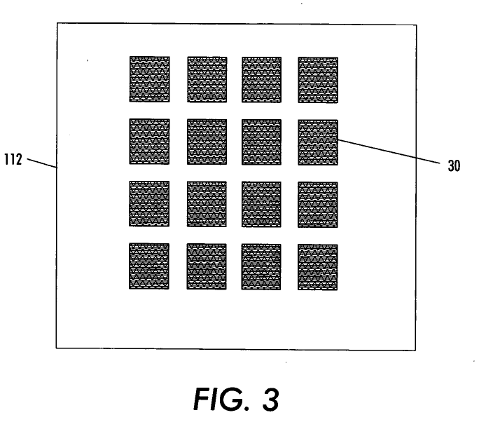

As shown in FIG. 3, the graphic user interface 112 can display a plurality of thumbnail images 30 of printing medium sheets, wherein each thumbnail image illustrates a thumbnail front-page overlaid on a thumbnail back page again using different colors.

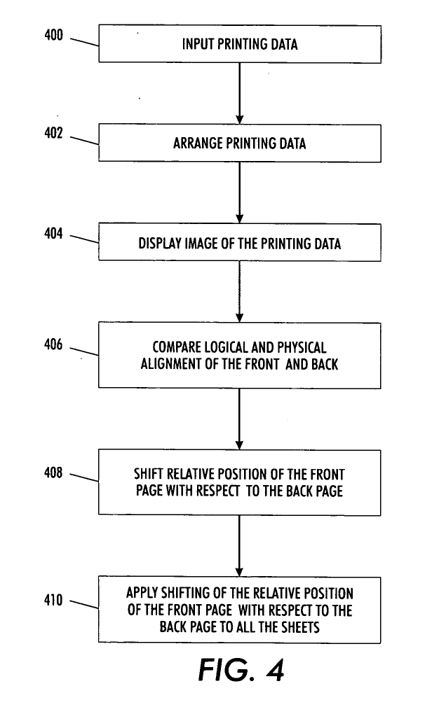

FIG. 4 illustrates embodiments herein in flowchart form. More specifically, in item 400, printing data is input. In item 402, the printing data is arranged to be printed on both sides of a printing medium. In item 404, an image of the printing data is displayed on a graphic user interface in a process that overlays the front page of the printing data on the back page of the printing data in the image, where the front page and the back page are displayed using different colors, different scaling, etc. in the image. The processing shown in item 404 also includes selecting (through the graphic user interface) colors for display of the front page and the back page.

The logical and physical alignment of the front and back are compared in item 406. If necessary, in item 408, the relative position of the front page is shifted with respect to the back page and/or the printing medium in the image using page offsets that uniformly adjust positions of all items in at least one of the front page and the back page. Also, the position of individual items within either the front page or back page can be changed in item 408. If desired, the shifting of the relative position of the front page with respect to the back page for one sheet of printing medium is applied to all the sheets or at least one group of sheets of the printing medium in item 410.

While the foregoing has been described in conjunction with various exemplary embodiments, it is to be understood that many alternatives, modifications and variations would be apparent to those skilled in the art. Accordingly, Applicants intend to embrace all such alternatives, modifications and variations that follow in this spirit and scope.

What is claimed is:

1. A printing system comprising:
an input adapted to receive printing data to be printed on both sides of a printing medium;
a processor adapted to arrange said printing data as an image; and
a graphic user interface adapted to display said image,
wherein said processor is further adapted to overlay a first page of said printing data on a next consecutive page of said printing data in said image, such that said first page and said next consecutive page are simultaneously displayed in said image as a one sided document image using different colors for said first page and said next consecutive page.

2. The system according to claim 1, wherein said graphic user interface includes inputs adapted to shift a relative position of said first page with respect to said next consecutive page in said image.

3. The system according to claim 2, wherein said printing data comprises data to be printed on multiple sheets of said printing medium, and wherein said graphic user interface further comprises an input adapted to apply shifting of said relative position of said first page with respect to said next consecutive page for one sheet of printing medium to at least one group of said sheets.

4. The system according to claim 1, wherein said graphic user interface further comprises an input adapted to select colors for display of said first page and said next consecutive page on said graphic user interface.

5. The system according to claim 1, wherein said graphic user interface is adapted to display a plurality of thumbnail images of printing medium sheets, wherein each thumbnail image illustrates a thumbnail first page overlaid on a thumbnail next consecutive page using different colors.

6. The system according to claim 1, wherein at least one of said first page and said next consecutive page comprise color printing data, and wherein said graphic user interface is adapted to display said first page and said next consecutive page using various color transformations.

7. The system according to claim 1, wherein said printing data comprises black and white image data, and wherein said graphic user interface is adapted to display said first page in black and white grayscale in said image, and display said next consecutive page using a color in said image.

8. A printing system comprising:
an input adapted to receive printing data to be printed on both sides of a printing medium;
a processor adapted to arrange said printing data as an image; and
a graphic user interface adapted to display said image,
wherein said processor is further adapted to overlay a first page of said printing data on a next consecutive page of said printing data in said image, such that said first page and said next consecutive page are simultaneously displayed in said image as a one sided document image using different colors for said first page and said next consecutive page, and
wherein said graphic user interface includes inputs adapted to move a position of one or more items relative to other items on one or more of said first page and said next consecutive page.

9. The system according to claim 8, wherein said printing data comprises data to be printed on multiple sheets of said printing medium, and wherein said graphic user interface further comprises an input adapted to apply moving of said position of one or more items for one sheet of said printing medium to at least one group of said sheets.

10. The system according to claim 8, wherein said graphic user interface further comprises an input adapted to select colors for display of said first page and said next consecutive page on said graphic user interface.

11. The system according to claim 8, wherein said graphic user interface is adapted to display a plurality of thumbnail images of printing medium sheets, wherein each thumbnail image illustrates a thumbnail first page overlaid on a thumbnail next consecutive page using different colors.

12. The system according to claim 8, wherein at least one of said first page and said next consecutive page comprise color printing data, and wherein said graphic user interface is adapted to display said first page and said next consecutive page using various color transformations.

13. The system according to claim 8, wherein said printing data comprises black and white image data, and wherein said graphic user interface is adapted to display said first page in black and white grayscale in said image, and display said next consecutive page using a color in said image.

14. The system according to claim 8, wherein said system comprises a xerox graphic system.

15. A printing method comprising:
inputting printing data arranged to be printed on both sides of a printing medium; and
displaying an image of said printing data on a graphic user interface,
wherein said displaying comprises overlaying a first page of said printing data on a next consecutive page of said printing data in said image, such that said first page and said next consecutive page are simultaneously displayed in said image as a one sided document image using different colors for said first page and said next consecutive page.

16. The method according to claim 15, further comprising shifting the relative position of said first page with respect to said next consecutive page in said image using page offsets that uniformly adjust positions of all items in at least one of said first page and said next consecutive page.

17. The method according to claim 16, wherein said printing data comprises data to be printed on multiple sheets of said printing medium, and wherein said method further comprises applying said shifting of said relative position of said first page with respect to said next consecutive page for one sheet of printing medium to at least one group of said sheets of said printing medium.

18. The method according to claim 15, further comprising selecting colors for display of said first page and said next consecutive page on said graphic user interface.

19. The method according to claim 15, wherein said displaying process displays a plurality of thumbnail images of printing medium sheets, wherein each thumbnail image illustrates a thumbnail first page overlaid on a thumbnail next consecutive page using different colors.

20. The method according to claim 15, wherein at least one of said first page and said next consecutive page comprise color printing data, and wherein said displaying process displays said first page and said next consecutive page using various color transformations in said image.

21. The method according to claim 15, wherein said printing data comprises black and white image data, and wherein said displaying process displays said first page in black and white grayscale in said image, and displays said next consecutive page using a color in said image.

22. A printing method comprising:
inputting printing data arranged to be printed on both sides of a printing medium;
displaying an image of said printing data on a graphic user interface, wherein said displaying comprises overlaying a first page of said printing data on a next consecutive page and said next consecutive page are simultaneously displayed in said image as a one sided document image using different colors for said first page and said next consecutive page; and
moving a position of one or more items relative to other items on one or more of said first page and said next consecutive page using said graphic user interface.

23. The method according to claim 22, further comprising shifting the relative position of said first page with respect to said next consecutive page in said image using page offsets that uniformly adjust positions of all items in at least one of said first page and said next consecutive page.

24. The method according to claim 23, wherein said printing data comprises data to be printed on multiple sheets of said printing medium, and wherein said method further comprises applying said shifting of said relative position of said first page with respect to said next consecutive page for one sheet of printing medium to at least one group of said sheets of said printing medium.

25. The method according to claim 22, further comprising selecting colors for display of said first page and said next consecutive page on said graphic user interface.

26. The method according to claim 22, wherein said displaying process displays a plurality of thumbnail images of printing medium sheets, wherein each thumbnail image illustrates a thumbnail first page overlaid on a thumbnail next consecutive page using different colors.

27. The method according to claim 22, wherein at least one of said first page and said next consecutive page comprise color printing data, and wherein said displaying process displays said first page and said next consecutive page using various color transformations in said image.

28. The method according to claim 22, wherein said printing data comprises black and white image data, and wherein said displaying process displays said first page in black and white grayscale in said image, and displays said next consecutive page using a color in said image.
